(19) United States
(12) Patent Application Publication
(10) Pub. No.: US 2013/0136396 A1
(43) Pub. Date: May 30, 2013

(54) GRATING COUPLER

(71) Applicants: Do Won KIM, Daejeon (KR); Gyungock Kim, Daejeon (KR)

(72) Inventors: Do Won KIM, Daejeon (KR); Gyungock Kim, Daejeon (KR)

(73) Assignee: Electronics and Telecommunications Research Institute, Daejeon (KR)

(21) Appl. No.: 13/620,636

(22) Filed: Sep. 14, 2012

(30) Foreign Application Priority Data
Nov. 25, 2011 (KR) 10-2011-0124214

(51) Int. Cl. G02B 6/34

(52) U.S. Cl. 385/37

(57) ABSTRACT

Disclosed is a grating coupler which includes an optical waveguide transferring an optical signal; and a diffraction grating formed on the optical waveguide. The diffraction grating includes protrusions continuously formed and the protrusions have different heights.

### CROSS-REFERENCE TO RELATED APPLICATIONS

A claim for priority under 35 U.S.C. §119 is made to Korean Patent Application No. 10-2011-0124214 filed Nov. 25, 2011, in the Korean Intellectual Property Office, the entire contents of which are hereby incorporated by reference.

### BACKGROUND

The inventive concepts described herein relate to an electronic device, and more particularly, relate to a memory system.

Continuous increase in information transfer speed may be required with rapid development of information communications technologies. As a method to be in the limelight in the information transfer field, optical interconnection using a silicon photonics technology may be actively researched. An optical data transfer technique may be characterized in that loss due to crosstalk and electromagnetic wave interference is less.

One of optical coupling techniques for coupling light with a silicon photonics IC may be to couple light using a grating coupler. Since a manner using the grating coupler has an advantage that light is vertically incident, a coupling may be easy. Further, it is possible to test the coupling at a wafer level. However, although the grating coupler is used, loss may still exist at an optical coupling process. Thus, it is required a technique for reducing optical loss of the grating coupler for efficient information transfer.

### SUMMARY

Example embodiments of the inventive concept provide a grating coupler comprising an optical waveguide transferring an optical signal; and a diffraction grating formed on the optical waveguide. The diffraction grating includes protrusions continuously formed and the protrusions have different heights.

In example embodiments, the heights of the protrusions increase with a constant ratio.

In example embodiments, the heights of the protrusions increase along a constant direction.

In example embodiments, the heights of the protrusions increase along a proceeding direction of an optical signal transferred from the grating coupler.

In example embodiments, the heights of the protrusions decrease with a constant ratio.

In example embodiments, the protrusions form groups each formed of at least one protrusion having the same height.

In example embodiments, the heights of the groups increase along a proceeding direction of an optical signal transferred from the grating coupler.

In example embodiments, the groups include a plurality of groups having different heights and iteratively disposed.

### BRIEF DESCRIPTION OF THE FIGURES

The above and other objects and features will become apparent from the following description with reference to the following figures, wherein like reference numerals refer to like parts throughout the various figures unless otherwise specified, and wherein

FIG. 1 is a cross-sectional view illustrating an optical interconnection structure between a grating coupler and an optical filter according to an embodiment of the inventive concept.

FIG. 2 is a cross-sectional view illustrating an optical interconnection structure between a grating coupler and an optical filter according to another embodiment of the inventive concept.

FIG. 3 is a graph illustrating the amplitude of an optical signal simulated at a grating coupler in FIG. 1.

FIG. 4 is a graph illustrating the net flux of an optical signal simulated at a grating coupler in FIG. 1.

FIG. 5 is a graph illustrating the amplitude of an optical signal simulated at a grating coupler in FIG. 2.

FIG. 6 is a graph illustrating the net flux of an optical signal simulated at a grating coupler in FIG. 2.

FIG. 7 is a cross-sectional view illustrating an optical interconnection structure between a grating coupler and an optical filter according to still another embodiment of the inventive concept.

FIG. 8 is a cross-sectional view illustrating an optical interconnection structure between a grating coupler and an optical filter according to still another embodiment of the inventive concept.

FIG. 9 is a graph illustrating the amplitude of an optical signal simulated at a grating coupler in FIG. 7.

FIG. 10 is a graph illustrating the net flux of an optical signal simulated at a grating coupler in FIG. 7.

### DETAILED DESCRIPTION

Embodiments will be described in detail with reference to the accompanying drawings. The inventive concept, however, may be embodied in various different forms, and should not be construed as being limited only to the illustrated embodiments. Rather, these embodiments are provided as examples so that this disclosure will be thorough and complete, and will fully convey the concept of the inventive concept to those skilled in the art. Accordingly, known processes, elements, and techniques are not described with respect to some of the embodiments of the inventive concept. Unless otherwise noted, like reference numerals denote like elements throughout the attached drawings and written description, and thus descriptions will not be repeated. In the drawings, the sizes and relative sizes of layers and regions may be exaggerated for clarity.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concept.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Also, the term “exemplary” is intended to refer to an example or illustration.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

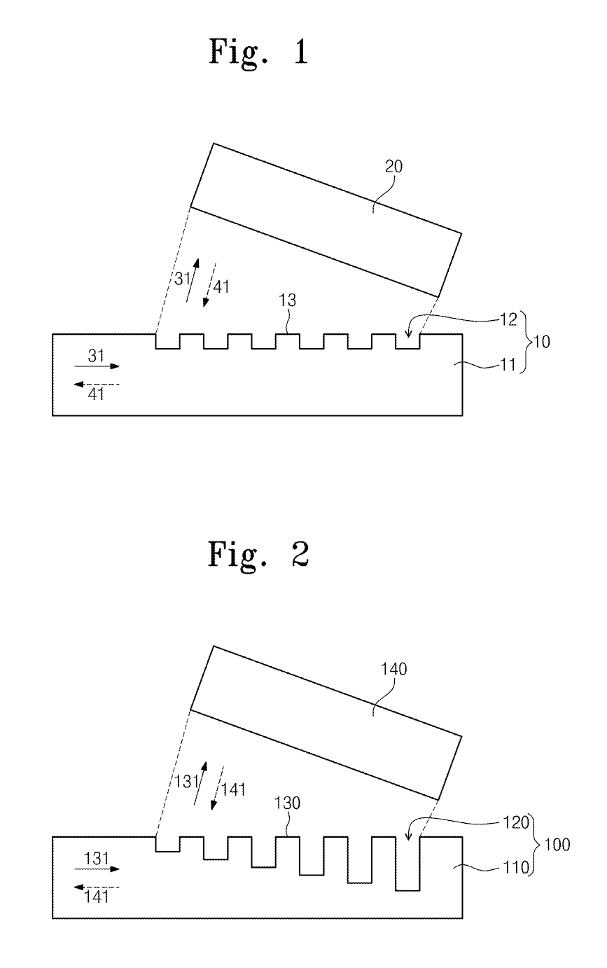

FIG. 1 is a cross-sectional view illustrating an optical interconnection structure between a grating coupler and an optical filter according to an embodiment of the inventive concept. Referring to FIG. 1, a grating coupler 10 may include an optical waveguide 11 and a diffraction grating 12.

The optical waveguide 11 may be an optical channel for transferring an optical signal. The optical waveguide 11 may extend along one direction parallel with an upper surface of the grating coupler 10. The one direction may be an x-axis direction as illustrated in FIG. 1. The optical waveguide 11 may propagate an optical signal 31 transferred from the inside of a circuit and an optical signal 41 incident from the outside of a circuit.

The diffraction grating 12 may be disposed on the optical waveguide 11. The diffraction grating 12 may include a plurality of protrusions 13. The protrusions 13 may be formed to have a constant depth and a constant width, and may constitute the diffraction grating 12. Both sidewalls of each of the protrusions 13 may be vertical to the one direction along which the optical waveguide 11 extends.

A grating size of the diffraction grating 12 formed of the protrusions 13 may be smaller than wave lengths of the optical signal 31 transferred via the optical waveguide 11 and the optical signal 41 incident from the outside of the circuit. Thus, the optical signals 31 and 41 may be reflected, diffracted, and scattered by the diffraction grating 12. In this case, optical paths of the optical signals 31 and 41 may be changed. This may make it possible to reduce optical loss when the optical signals 31 and 41 pass the grating coupler 10.

The optical fiber 20 may be provided over the grating coupler 10. The optical signal 41 output from the optical fiber 20 may be transferred to the optical waveguide 11 through the diffraction grating 12 of the grating coupler 10. A transfer of an optical signal via the grating coupler 10 may be reversible. That is, the optical signal 31 may be transferred to the optical fiber 20 from the optical waveguide 11 through the diffraction grating 12.

The optical signal 41 output from the optical fiber 20 may be vertically incident onto an upper surface of the grating coupler 10. However, the optical signal 41 can be incident onto an upper surface of the grating coupler 10 with a predetermined angle. This may enable loss between the optical fiber 20 and the grating coupler 10 to be reduced.

The grating coupler may reduce loss due to optical coupling by providing a diffraction grating formed of protrusions each having a constant size. However, the grating coupler of the inventive concept may have optical loss due to light emitted from one end of an optical waveguide, optical loss due to light emitted from a lower surface of the grating coupler and going through the optical waveguide, optical loss generated at optical coupling with an optical fiber, and optical loss due to mode mismatch between the grating coupler and the optical fiber. Thus, to improve the optical coupling efficiency, the inventive concept may reduce optical loss by changing a height of a grating forming a diffraction grating of a grating coupler.

FIG. 2 is a cross-sectional view illustrating an optical interconnection structure between a grating coupler and an optical filter according to another embodiment of the inventive concept. Referring to FIG. 2, a grating coupler 100 may include an optical waveguide 110 and a diffraction grating 120.

The optical waveguide 110 may be analogous to that 11 in FIG. 1. The optical waveguide 110 may propagate an optical signal 131 transferred from the inside of a circuit and an optical signal 141 incident from the outside of the circuit.

The diffraction grating 120 may include protrusions 130. The protrusions 130 may be continuously formed to form the diffraction grating 120. Heights of the protrusions 130 may increase along a direction in which the optical signal 131 proceeds.

The optical signal 131 may be transferred to an optical fiber 140 from the optical waveguide 110 through the diffraction grating 120. The optical signal 131 transferred to the optical waveguide 110 may first arrive at the diffraction grating 120. A wavelength of the optical signal 131 may be longer than a width of the diffraction grating 120. Thus, the optical signal 131 may be reflected, diffracted, and scattered by the diffraction grating 120.

The optical signal 141 may be propagated to the optical waveguide 110 from the optical fiber 140 through the diffraction grating 120. The optical signal 141 incident from the optical fiber 140 may first arrive at the diffraction grating 120. A wavelength of the optical signal 141 may be longer than a width of the diffraction grating 120. Thus, the optical signal 141 may be reflected, diffracted, and scattered by the diffraction grating 120.

As heights of the protrusions 130 increase along a direction in which the optical signal 131 transfers, a height of the diffraction grating 120 may become deeper. Thus, reflection, scattering, and diffraction levels may be sequentially changed when the optical signal 131 is transferred to the optical fiber 140 through the diffraction grating 120. This may make it possible to reduce optical loss when the optical signal 131 is transferred to the optical fiber 140. Likewise, reflection, scattering, and diffraction levels may be sequentially changed when the optical signal 141 is transferred to the optical waveguide 110 through the diffraction grating 120. This may make it possible to reduce optical loss when the optical signal 141 is transferred to the optical waveguide 110. In example embodiments, heights of the protrusions 130 may increase with a predetermined ratio.

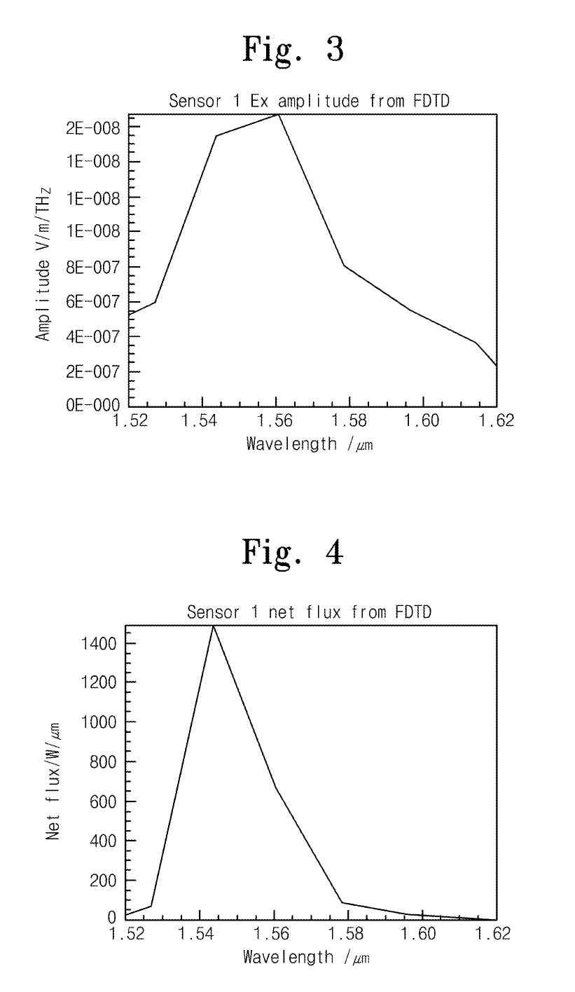

FIG. 3 is a graph illustrating the amplitude of an optical signal simulated at a grating coupler in FIG. 1.

FIG. 4 is a graph illustrating the net flux of an optical signal simulated at a grating coupler in FIG. 1.

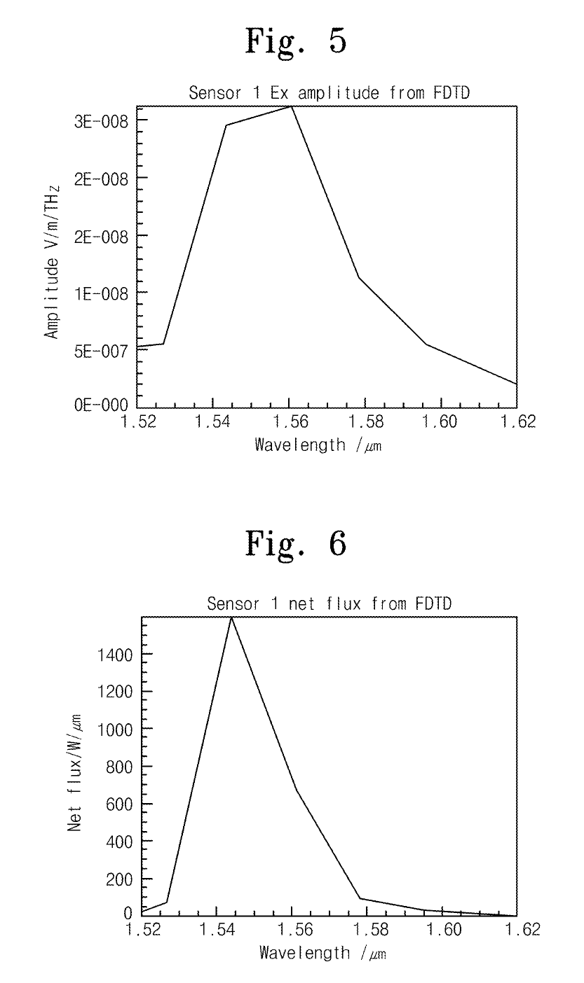

FIG. 5 is a graph illustrating the amplitude of an optical signal simulated at a grating coupler in FIG. 2.

FIG. 6 is a graph illustrating the net flux of an optical signal simulated at a grating coupler in FIG. 2.

Referring to FIGS. 3 to 6, optical loss of a grating coupler in FIG. 2 may be less than optical loss of a grating coupler in which diffraction gratings are structured to have a constant height. The optical signal may be measured at a location that is 700 nm away from a lower portion of a grating coupler to be the same as a condition of a grating coupler under test.

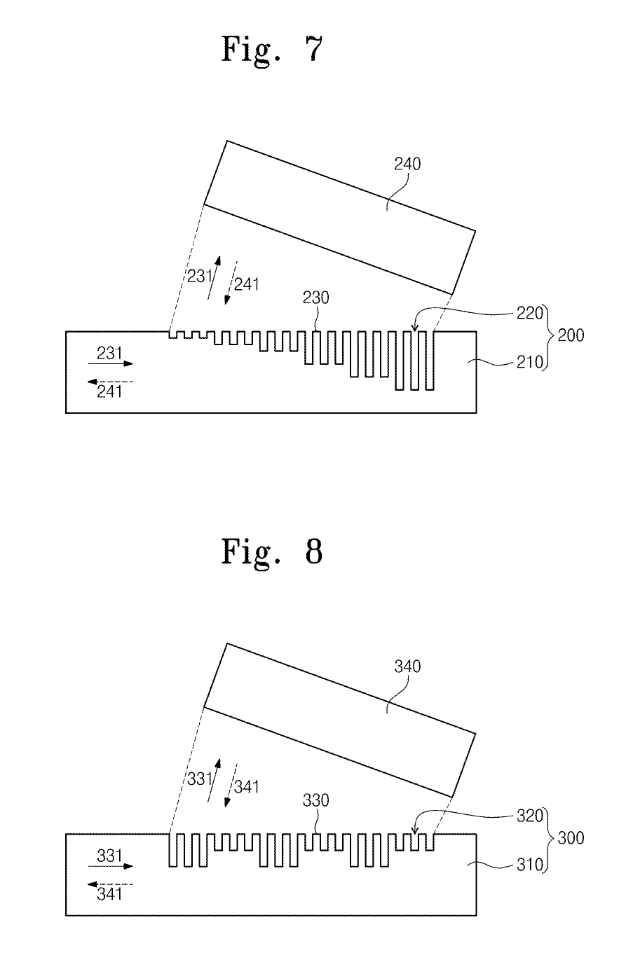

FIG. 7 is a cross-sectional view illustrating an optical interconnection structure between a grating coupler and an optical filter according to still another embodiment of the inventive concept. Referring to FIG. 7, a grating coupler 200 may include an optical waveguide 210 and a diffraction grating 220.

The optical waveguide 210 may transmit an optical signal 231 transferred from the inside of a circuit and an optical signal 241 incident from the outside of the circuit.

The diffraction grating 220 may include protrusions 230. The protrusions 230 may be continuously formed to constitute the diffraction grating 220. The protrusions 230 may be divided into a plurality of groups. Protrusions 130 in each group may have the same height. The diffraction grating 220 may be formed of protrusion groups the heights of which increase along a direction in which the optical signal 231 proceeds.

The optical signal 231 may be transferred to the optical fiber 240 from the optical waveguide 210 through the diffraction grating 220. At this time, the grouped protrusions 230 may enable a height of the diffraction grating 220 to increase along a direction in which the optical signal 231 proceeds.

Thus, reflection, scattering, and diffraction levels may be sequentially changed when the optical signal 231 is transferred to the optical fiber 240 through the diffraction grating 220. This may make it possible to reduce optical loss when the optical signal 231 is transferred to the optical fiber 240. Likewise, reflection, scattering, and diffraction levels may be sequentially changed when the optical signal 241 is transferred to the optical waveguide 210 through the diffraction grating 220. This may make it possible to reduce optical loss when the optical signal 241 is transferred to the optical waveguide 210.

FIG. 8 is a cross-sectional view illustrating an optical interconnection structure between a grating coupler and an optical filter according to still another embodiment of the inventive concept. Referring to FIG. 8, a grating coupler 300 may include an optical waveguide 310 and a diffraction grating 320.

The optical waveguide 310 may transmit an optical signal 331 transferred from the inside of a circuit and an optical signal 341 incident from the outside of the circuit.

The diffraction grating 320 may include protrusions 330. The protrusions 330 may be continuously formed to constitute the diffraction grating 320. The protrusions 330 may be divided into a plurality of groups. Protrusions 330 in each group may have the same height. The diffraction grating 320 may be formed such that a first group of protrusions, each having a first height, and a second group of protrusions, each having a second height different from the first height, are repeated in turn.

The optical signal 331 may be transferred to the optical fiber 340 from the optical waveguide 310 through the diffraction grating 320. The optical signal 331 transferred to the optical waveguide 310 may first arrive at the diffraction grating 320. At this time, the diffraction grating 320 may have an iterative height. Thus, reflection, scattering, and diffraction levels may be sequentially changed when the optical signal 331 is transferred to the optical fiber 340 through the diffraction grating 320. This may make it possible to reduce optical loss when the optical signal 331 is transferred to the optical fiber 340. Likewise, reflection, scattering, and diffraction levels may be sequentially changed when the optical signal 341 is transferred to the optical waveguide 310 through the diffraction grating 320. This may make it possible to reduce optical loss when the optical signal 341 is transferred to the optical waveguide 310.

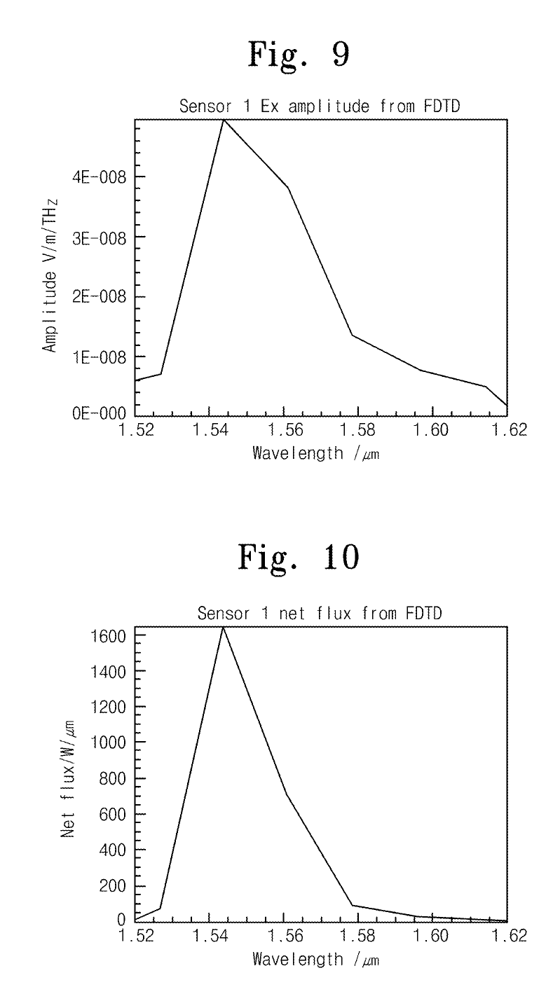

FIG. 9 is a graph illustrating the amplitude of an optical signal simulated at a grating coupler in FIG. 7.

FIG. 10 is a graph illustrating the net flux of an optical signal simulated at a grating coupler in FIG. 7.

Referring to FIGS. 3, 4, 9, and 10, optical loss of a grating coupler in FIG. 8 may be less than optical loss of a grating coupler in which diffraction gratings are structured to have a constant height. The optical signal may be measured at a location that is 700 nm away from a lower portion of a grating coupler to be the same as a condition of a grating coupler under test.

The inventive concept is described using a grating coupler in which a grating depth increases in a predetermined direction and a grating coupler having an iterative grating depth. However, the inventive concept is not limited thereto. The inventive concept may be applied to all grating couplers reducing optical loss through gratings having different depths.

While the inventive concept has been described with reference to exemplary embodiments, it will be apparent to those skilled in the art that various changes and modifications may be made without departing from the spirit and scope of the present invention. Therefore, it should be understood that the above embodiments are not limiting, but illustrative.

What is claimed is:

1. A grating coupler comprising:
an optical waveguide transferring an optical signal; and
a diffraction grating formed on the optical waveguide,
wherein the diffraction grating includes protrusions continuously formed and the protrusions have different heights.

2. The grating coupler of claim 1, wherein the heights of the protrusions increase with a constant ratio.

3. The grating coupler of claim 1, wherein the heights of the protrusions increase along a constant direction.

4. The grating coupler of claim 3, wherein the heights of the protrusions increase along a proceeding direction of an optical signal transferred from the grating coupler.

5. The grating coupler of claim 1, wherein the heights of the protrusions decrease with a constant ratio.

6. The grating coupler of claim 1, wherein the protrusions form groups each formed of at least one protrusion having the same height.

7. The grating coupler of claim 6, wherein the heights of the groups increase along a proceeding direction of an optical signal transferred from the grating coupler.

8. The grating coupler of claim 6, wherein the groups include a plurality of groups having different heights and iteratively disposed.
